(19) United States
(12) Patent Application Publication
(10) Pub. No.: US 2018/0232124 A1
(43) Pub. Date: Aug. 16, 2018

(54) Systems and Methods for Generating and Sharing Motion Picture Information

(71) Applicant: Zoe Van Brunt, Los Angeles, CA (US)

(72) Inventor: Zoe Van Brunt, Los Angeles, CA (US)

(21) Appl. No.: 15/894,710

(22) Filed: Feb. 12, 2018

Related U.S. Application Data
(60) Provisional application No. 62/458,499, filed on Feb. 13, 2017.

(51) Int. Cl. G06F 3/0489; G06F 3/0482; G06F 17/30; G06F 3/0484

(52) U.S. Cl. CPC G06F 3/0489; G06F 3/04847; G06F 17/3082; G06F 3/0482

(57) ABSTRACT

Systems, methods, and non-transitory computer-readable media can receive updated motion picture information for a motion picture production based on user interaction with an entry editor interface. Motion picture information associated with the motion picture production is updated within a data store based on the updated motion picture information received from the first user. A second user is provided with the updated motion picture information.

### CROSS-REFERENCE TO RELATED APPLICATIONS

This application claims priority to U.S. Provisional Patent Application No. 62/458,499, filed Feb. 13, 2017 and entitled “SYSTEMS AND METHODS FOR GENERATING AND SHARING MOTION PICTURE INFORMATION,” which is hereby incorporated by reference in its entirety as if fully set forth herein.

### FIELD OF THE INVENTION

The present technology relates to motion picture and photographic information. More particularly, the present technology relates to digital user interfaces for generating, storing and sharing motion picture and photographic information.

### BACKGROUND

Production of motion pictures can be an exceptionally complicated task requiring a large number of components to work harmoniously to produce a coherent piece. For example, large numbers of cast and crew may have to work in various locations and with disjointed schedules. Individual scenes may require numerous takes from different angles, and portions of multiple takes may have to be spliced together to create a single scene. As such, even a short scene comprising only a few seconds of the motion picture may be shot over the course of multiple days. Due to the complicated nature of motion picture productions, it is important that detailed, and accurate information be kept to ensure that various scenes and/or takes are consistent with one another.

### SUMMARY

Various embodiments of the present disclosure can include systems, methods, and non-transitory computer readable media configured to receive updated motion picture information for a motion picture production based on user interaction with an entry editor interface. Motion picture information associated with the motion picture production is updated within a data store based on the updated motion picture information received from the first user. A second user is provided with the updated motion picture information.

In an embodiment, the entry editor interface comprises a plurality of entry fields, and each entry field of the plurality of entry fields is associated with a field-specific keyboard for entering data into the entry field.

In an embodiment, a first field-specific keyboard associated with a first entry field comprises a specialized key.

In an embodiment, the first entry field is a lens entry field, and the specialized key is a lenses key which allows a user to select a lens from a set of pre-defined lenses.

In an embodiment, the first entry field is a stop entry field, and the specialized key is a fractional key which enters a pre-defined fractional value when selected by a user.

In an embodiment, the first entry field is a time code entry field, and the specialized key is a current time key which enters a current time when selected by a user.

In an embodiment, the first entry field is a shutter entry field, and the specialized key is a predefined shutter value key which enters a predefined shutter value when selected by a user.

In an embodiment, the first entry field is a color temperature entry field, and the specialized key is a predefined color temperature value key which enters a predefined color temperature value when selected by a user.

In an embodiment, the first entry field is a FPS entry field, and the specialized key is a predefined FPS value key which enters a predefined FPS value when selected by a user.

In an embodiment, the first entry field is an ISO entry field, and the specialized key is a predefined ISO value key which enters a predefined ISO value when selected by a user.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including a motion picture production module, according to an embodiment of the present disclosure.

FIG. 2A illustrates an example production selection interface, according to an embodiment of the present disclosure.

FIG. 2B illustrates an example camera selection interface, according to an embodiment of the present disclosure.

FIG. 2C illustrates an example entry selection interface, according to an embodiment of the present disclosure.

FIG. 2D illustrates an example entry editor interface, according to an embodiment of the present disclosure.

FIGS. 3A-3Q illustrate various exemplary field-specific keyboards, according to various embodiments of the present disclosure.

FIG. 4A illustrates an example production editor interface, according to an embodiment of the present disclosure.

FIG. 4B illustrates an example entry field editor interface, according to an embodiment of the present disclosure.

FIG. 4C illustrates an example filter editor interface, according to an embodiment of the present disclosure.

FIG. 4D illustrates an example lens editor interface, according to an embodiment of the present disclosure.

FIG. 4E illustrates an example character editor interface, according to an embodiment of the present disclosure.

FIG. 4F illustrates an example user editor interface, according to an embodiment of the present disclosure.

FIGS. 5A-5B illustrate an example camera editor interface, according to an embodiment of the present disclosure.

FIG. 6 illustrates an example method associated with updating and sharing motion picture information using a motion picture production application, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Motion Picture Information Generation and Sharing

Production of motion pictures can be an exceptionally complicated task requiring a large number of components to work harmoniously to produce a coherent piece. For example, large numbers of cast and crew may have to work in various locations and with disjointed schedules. Individual scenes may require numerous takes from different angles, and portions of multiple takes may have to be spliced together to create a single scene. As such, even a short scene comprising only a few seconds of the motion picture may be shot over the course of multiple days. Due to the complicated nature of motion picture productions, it is important that detailed, and accurate information be kept to ensure that various scenes and/or takes are consistent with one another.

Conventional approaches to motion picture production have involved users taking copious hand-written notes about scenes and takes. However, the information contained in these notes typically need to be shared amongst various members of the cast and/or crew to ensure that every person required for a particular scene or shoot is on the same page. When it is considered that motion picture productions can include thousands of individuals, and detailed information must be taken down for each and every take for each and every scene, it can be appreciated that the resources expended in gathering and sharing notes can be enormous. Certain conventional approaches have utilized computer technology in an attempt to address these issues. For example, users may take electronic notes that can be shared digitally, e.g., via email or other messaging applications. However, even in such scenarios, the data being recorded and shared tends to be more or less unstructured, and generally unwieldy and difficult to work with.

An improved approach rooted in computer technology overcomes the foregoing and other disadvantages associated with conventional approaches specifically arising in the realm of computer technology. Based on computer technology, the disclosed technology provides techniques for data input and sharing, for example, for a motion picture production. In certain embodiments, a motion picture production application is provided to one or more users involved with a motion picture production on their computing devices (such as a mobile device). Within the motion picture production application, each user can view various productions that the user is involved in. Each production can include one or more cameras, and each camera can include one or more entries. Each entry can be associated with, for example, one or more takes of a scene in a motion picture. Each entry can include one or more fields in which users can define field values that store relevant motion picture information. For example, an entry can include the following types of information fields: scene number, roll number, take number(s), lens information, stop information, focus distance, lens height, filter information, shutter angle, frames per second, color temperature, ISO, time stamp, lens tilt, film stock, scene description notes, and the like. This information can be used, for example, to re-create or re-shoot various shots, or to get different angles or different performances of a single shot, with settings that are as close as possible to an original shot or as close as possible to one another to ensure visual consistency. By creating various takes or shots with as much visual consistency as possible, the work required in post-production or digital effects can be decreased or minimized. Various fields can be associated with field-specific keyboards that are associated with and/or specifically designed for a particular field. For example, a “Lens” field can be associated with a lens-field-specific keyboard that includes specialized keys that allow a user to define a focal length and a lens type quickly and efficiently. Or a “Filter” field can be associated with a filter-field-specific keyboard that includes specialized keys for pre-defined filter types and filter weights. More examples will be described in greater detail herein. By providing customized field-specific keyboards associated with particular fields, data can be entered into the application in a structured, useful manner much more quickly and efficiently than in conventional methods.

In various embodiments, the motion picture production application can communicate over a network such that motion picture information can be communicated over the network to multiple users. For example, when a user adds or revises information for a particular production on the application installed on his or her computing device, a set of additional users that are also associated with the production can receive updated information on the applications installed on their respective computing devices such that all users associated with the production are consistently provided with up-to-date information. In certain embodiments, information entered into the application can be utilized in post-production processes (e.g., provided to post-production software and/or digital effects software), and/or utilized in subsequent shots or takes (e.g., used to set camera settings for subsequent takes or shots).

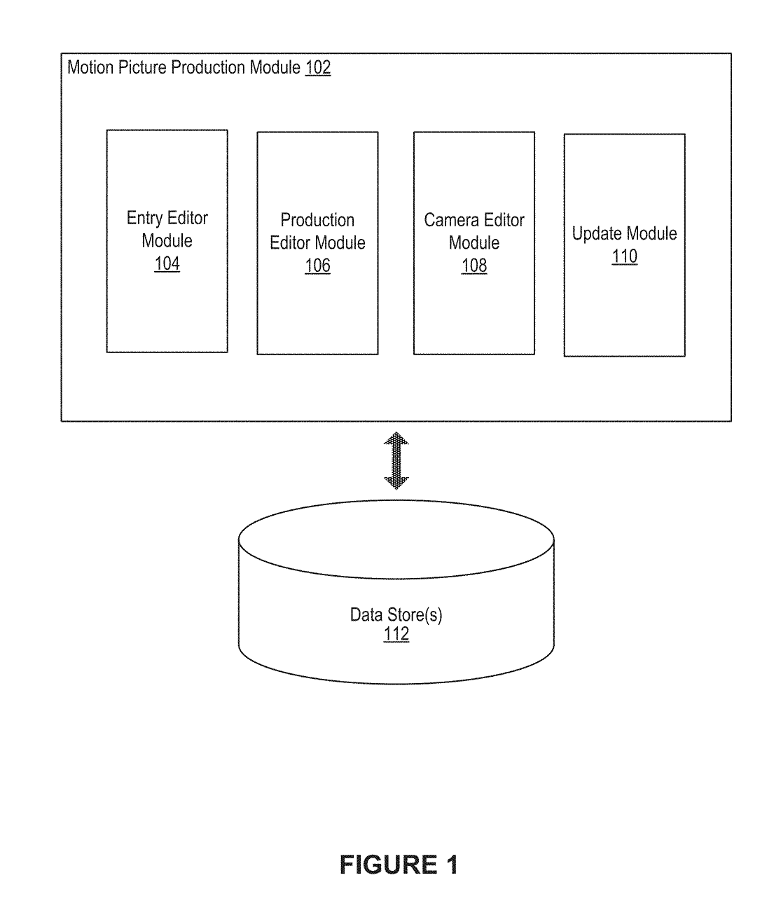

FIG. 1 illustrates an example system 100 including a motion picture production module 102, according to an embodiment of the present disclosure. The motion picture production module 102 can be configured to receive, store, and disseminate motion picture production information. In one embodiment, the motion picture production module 102 can provide a set of customizable user interfaces for receiving and displaying motion picture production information. The set of customizable user interfaces may be provided, for example, via a motion picture production application running on a user's computing device. A particular user may be involved in one or more motion picture productions. Using the set of customizable user interfaces, a user can view various productions that the user is involved in. Each production can include and/or be associated with one or more cameras, and each camera can include and/or be associated with one or more entries. Each entry can be associated with, for example, one or more takes of a scene in a motion picture. Each entry can include one or more fields in which users can define field values that store relevant motion picture information.

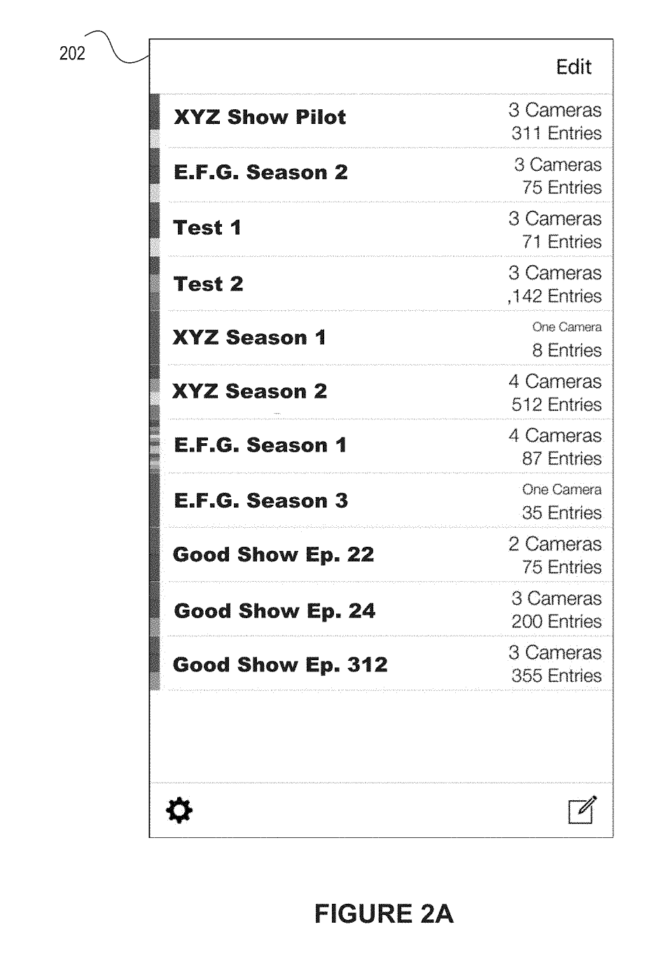

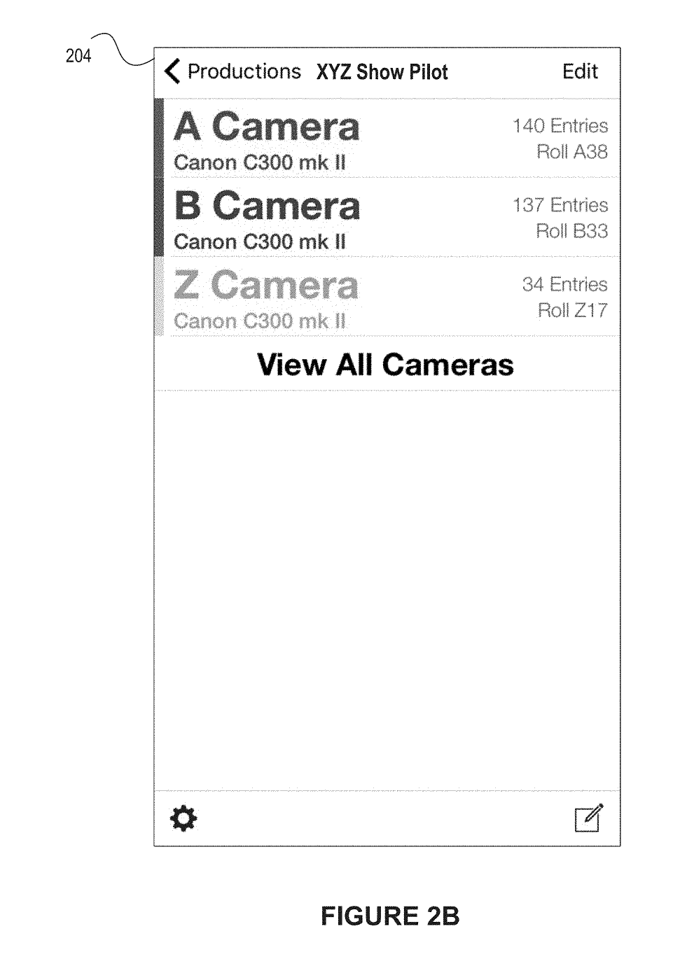

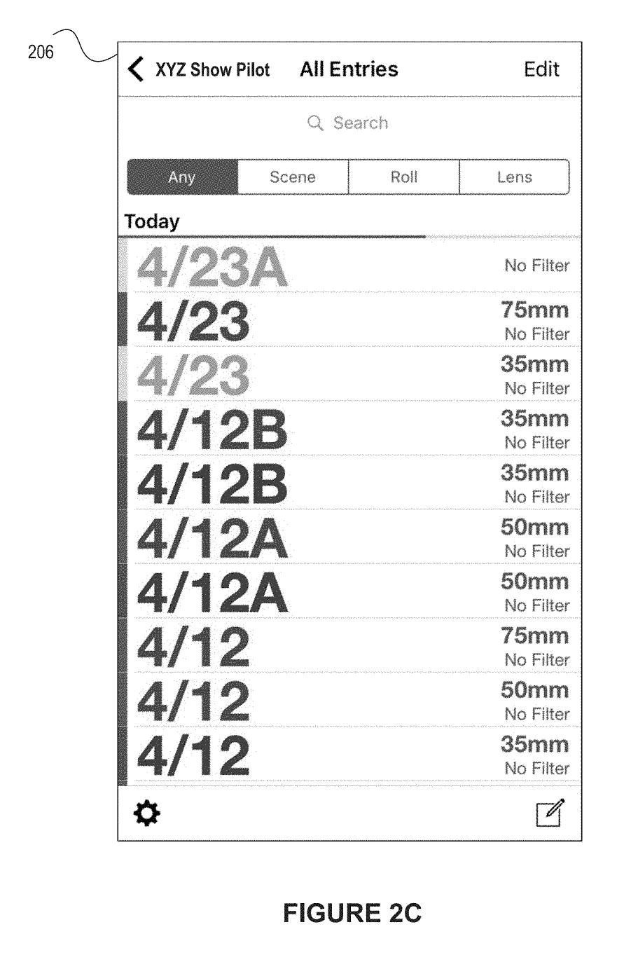

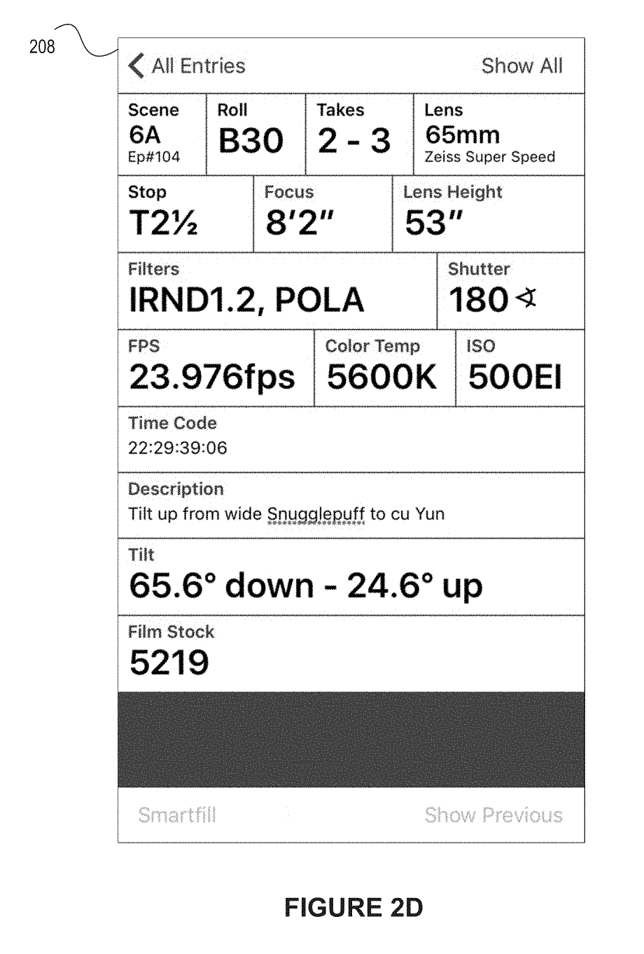

FIGS. 2A-2D illustrate various example user interfaces that will provide an introduction to one embodiment of a motion picture production application, various embodiments and features of which are described herein. FIG. 2A illustrates an example production selection interface 202, according to an embodiment of the present disclosure. A user can utilize the production selection interface 202 to view one or more productions that the user is associated with. In the example production selection interface 202, the user is associated with eleven different productions: XYZ Show Pilot; E.F.G. Season 2; Test 1; Test 2; XYZ Season 1; XYZ Season 2; E.F.G. Season 1; E.F.G. Season 3; Good Show Ep. 22; Good Show Ep. 24; and Good Show Ep. 312. The user can select a production to view more details about that production.

FIG. 2B illustrates an example camera selection interface 204. In the example scenario depicted, the user has selected the production “XYZ Show Pilot” from the production selection interface 202 to access the camera selection interface 204. The camera selection interface 204 shows some or all of the cameras associated with the production “XYZ Show Pilot.” In one embodiment, each camera is associated with a particular color. For example, in the example camera selection interface 204, the camera “A Camera” can be associated with the color red, the camera “B Camera” can be associated with the color blue, and the camera “Z Camera” can be associated with the color gold. A user can select a camera from the camera selection interface 204 to view any entries associated with the camera. The user can also select a “View All Cameras” option to view all entries associated with all cameras.

FIG. 2C illustrates an example entry selection interface 206. In the depicted example scenario, a user has selected the “View All Cameras” option from the camera selection interface 204 to access the entry selection interface 206. As noted above, each entry can be associated with one or more takes of a scene, and can also be associated with a camera that was used to capture those one or more takes. The listing of entries can be color-coded such that each entry is colored according to the camera it is associated with. For example, as discussed above, the A Camera may be associated with the color red, the B Camera may be associated with the color blue, and the Z Camera may be associated with the color gold. As such, any entries associated with the A Camera can be colored red, any entries associated with the B Camera can be colored blue, and any entries associated with the Z Camera can be colored gold.

FIG. 2D illustrates an example entry editor interface 208. As noted above, each entry can be associated with a particular take or set of takes. A user can utilize the entry editor interface 208 to enter details (i.e., motion picture information) about a particular take or set of takes. Each of these interfaces, and others, will be described in greater detail herein.

Returning to FIG. 1, the motion picture production module 102 can, in various embodiments, be configured to communicate over a network such that motion picture information can be communicated over the network to multiple users. For example, when a user adds or revises information for a particular production on the application installed on his or her computing device, a set of users that are also associated with the production can receive updated information on the applications installed on their respective computing devices such that all users on the production are consistently provided with up-to-date information. In certain embodiments, information entered into the application can be utilized in post-production processes (e.g., provided to post-production software and/or digital effects software), and/or utilized in subsequent shots or takes (e.g., used to set camera settings for subsequent takes or shots).

As shown in the example of FIG. 1, the motion picture production module 102 can include an entry editor module 104, a production editor module 106, a camera editor module 108, and an update module 110. In some instances, the example system 100 can include at least one data store 112. The components (e.g., modules, elements, etc.) shown in this figure and all figures herein are exemplary only, and other implementations may include additional, fewer, integrated, or different components. Some components may not be shown so as not to obscure relevant details. In various embodiments, one or more of the functionalities described in connection with the motion picture production module 102 can be implemented in any suitable combinations.

In some embodiments, the motion picture production module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the motion picture production module 102 can be, in part or in whole, implemented as software running on one or more computing devices or systems, such as on a server system or a client computing device. In some instances, the motion picture production module 102 can be, in part or in whole, implemented within or configured to operate in conjunction with or be integrated with a client computing device. It should be understood that many variations are possible.

The motion picture production module 102 can be configured to communicate and/or operate with the at least one data store 112, as shown in the example system 100. The data store 112 can be configured to store and maintain various types of data. In some embodiments, the data store 112 can store information that is utilized by the motion picture production module 102. For example, the data store 112 can store motion picture information provided by users associated with a production. It is contemplated that there can be many variations or other possibilities.

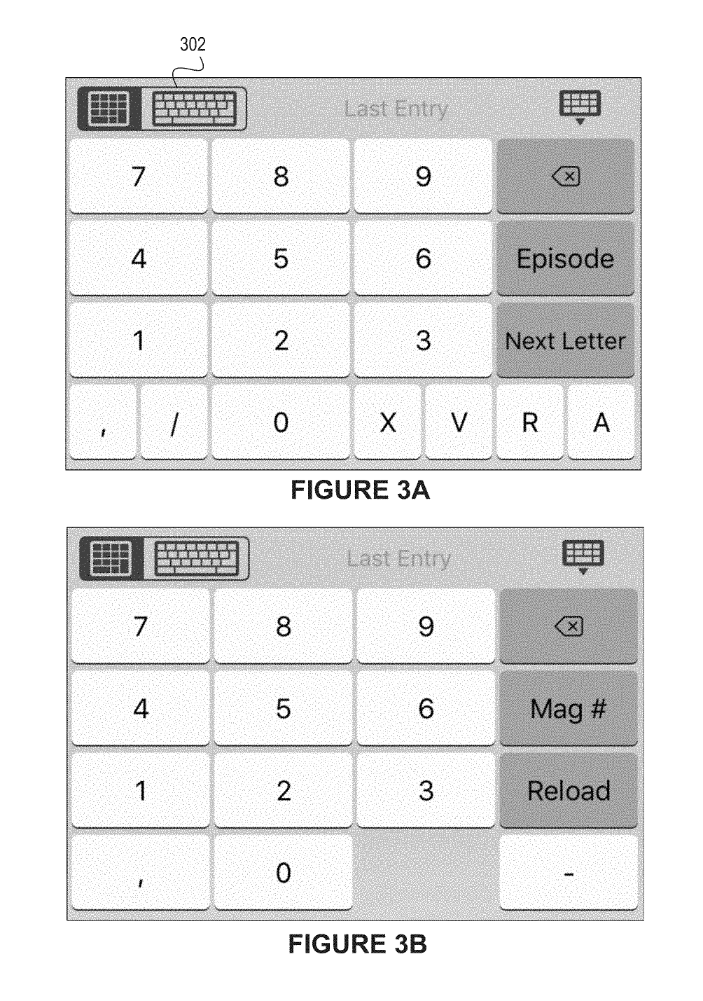

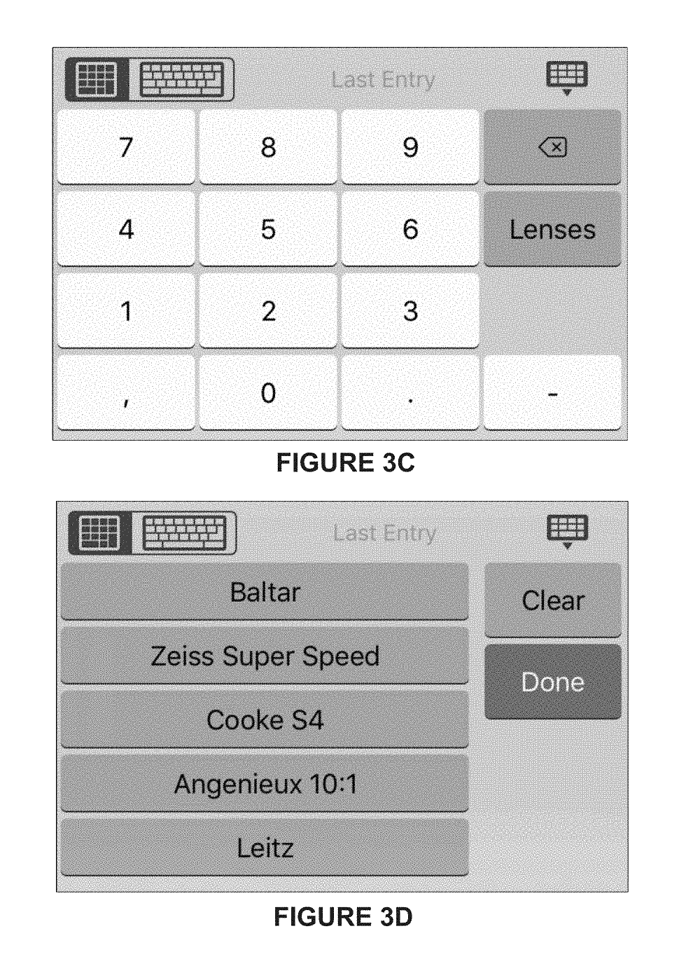

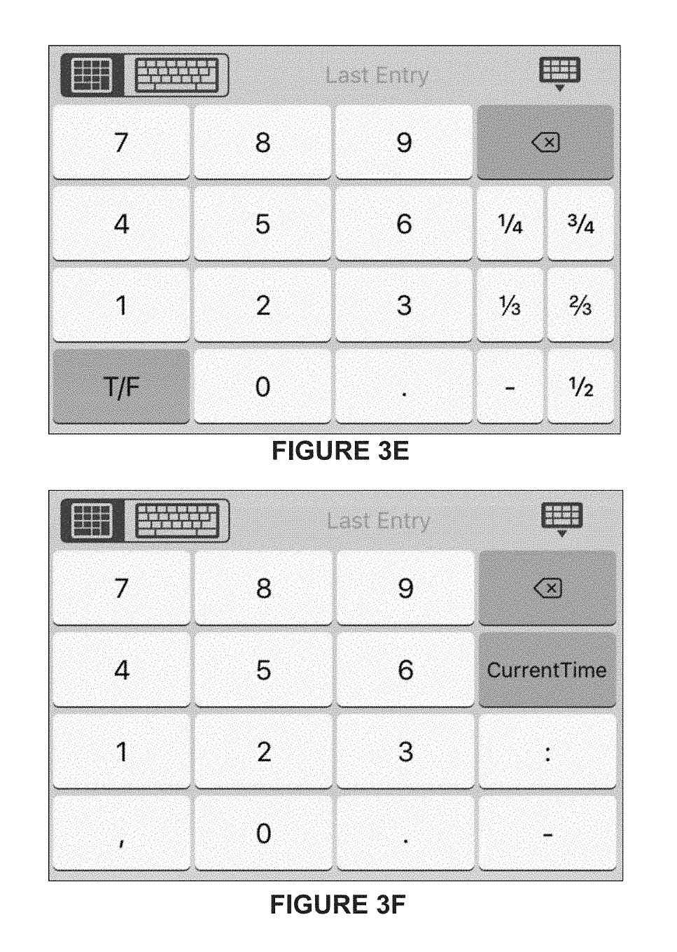

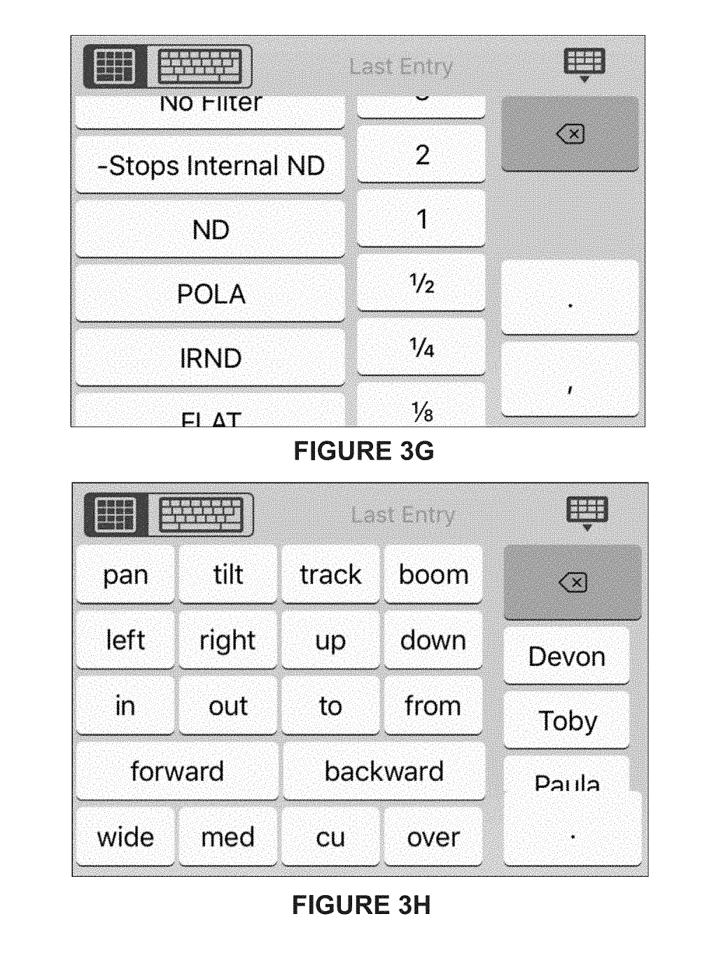

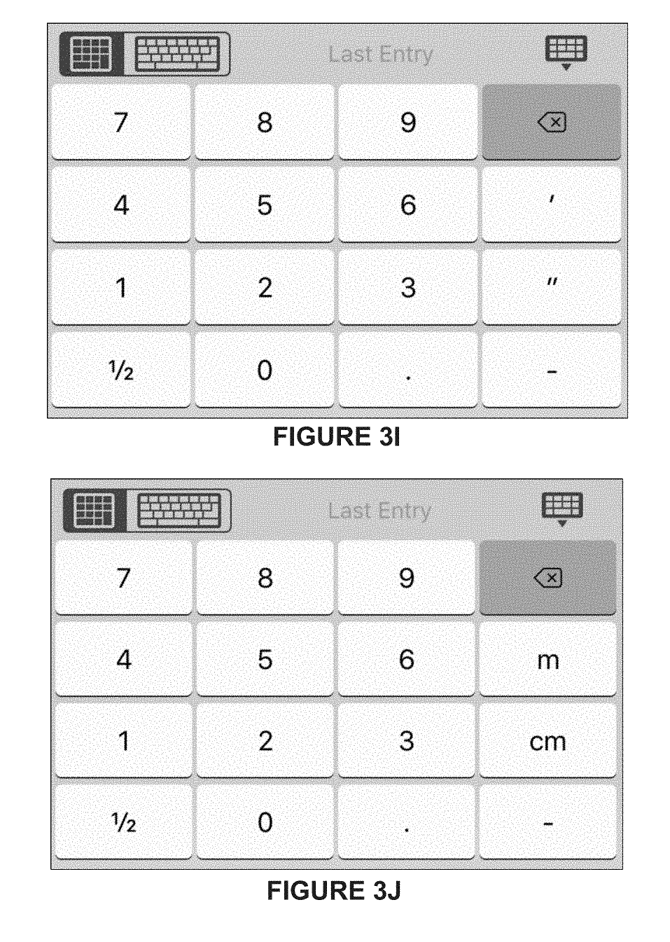

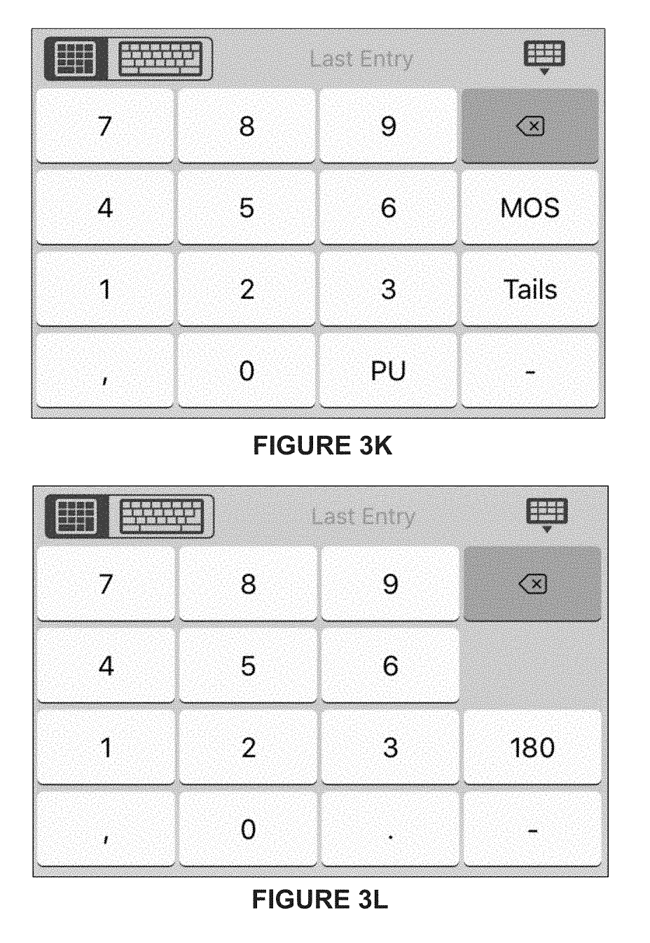

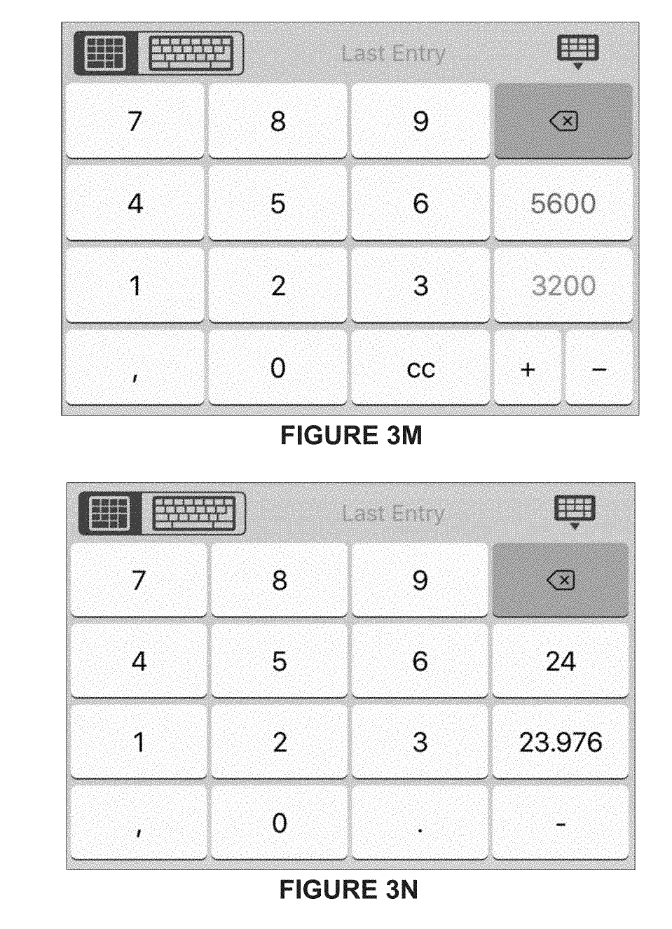

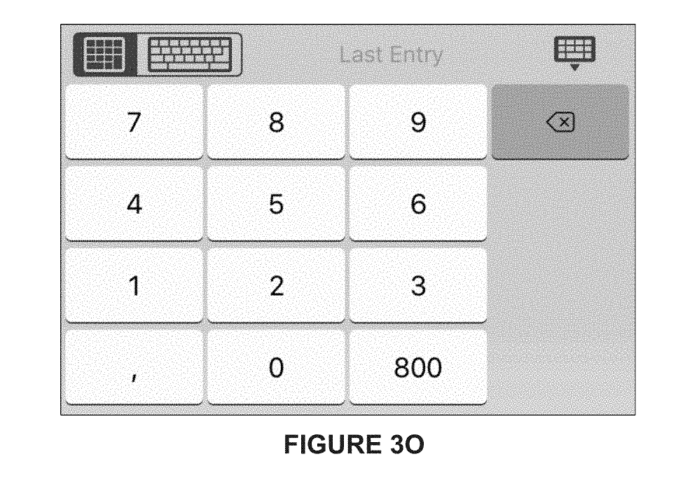

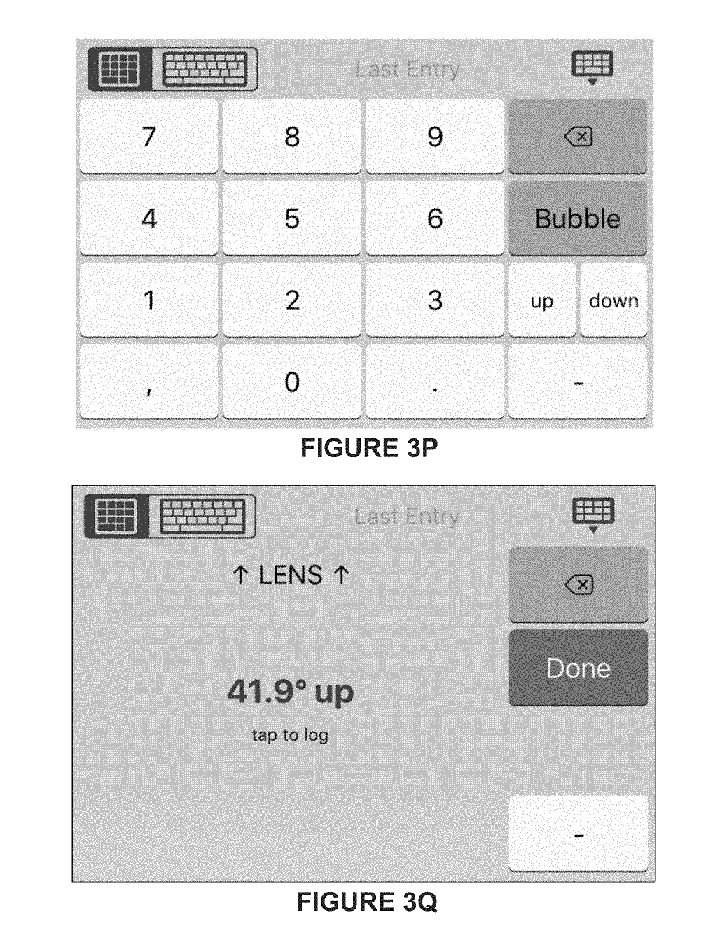

The entry editor module 104 can be configured to implement an entry editor interface via which a user can enter motion picture information relating to a motion picture production. An example entry editor interface 208 is depicted in FIG. 2D. The entry editor interface 208 corresponds to a single entry, which may be associated with a camera, which may be associated with a production. As can be seen, the entry has a plurality of fields (e.g., scene, roll, takes, lens, stop, focus, lens height, filters, shutter, FPS, color temp, ISO, time code, description, tilt, film stock). The user can use the entry editor interface to view and/or revise each field. As noted above, each field in the entry editor interface may be associated with a field-specific keyboard for entering information into the field. The field-specific keyboard may be customized and/or tailored in order to more efficiently enter information for the field associated with the field-specific keyboard. In one embodiment, a field-specific keyboard can include a combination of keys that are unique to that field-specific keyboard. In one embodiment, the combination of keys that define a field-specific keyboard can include one or more specialized keys. Specialized keys may be keys that are not included in a typical QWERTY keyboard (e.g., are not keys for a particular alphanumeric character or punctuation mark), and, in some instances, may be unique to a particular field-specific keyboard. In one embodiment, the entry editor module 104 can be configured to provide users with an option to toggle between a regular keyboard (e.g., a QWERTY keyboard), and a field-specific keyboard. As can be seen in FIG. 2D, the example entry editor interface 208 includes a scene field, a roll field, a takes field, a lens field, a stop field, a focus field, a lens height field, a filters field, a shutter field, an FPS field, a color temp field, an ISO field, a time code field, a description field, a tilt field, and a film stock field. Various examples of field-specific keyboards corresponding to these example fields are depicted in FIGS. 3A-3Q, each of which will now be described in greater detail.

FIG. 3A depicts an example scene-field-specific keyboard that is associated with the “scene” field, such that a user can quickly and efficiently enter scene number information, according to an embodiment of the present disclosure. The scene-field-specific keyboard provides numerical keys to enter a scene number, as well as various additional alphanumeric keys (X V R A) and punctuation keys (, /) that are commonly used when entering information in the scene field. The scene-field-specific keyboard also includes two specialized keys that are unique to the scene-field-specific keyboard: an “Episode” key and a “Next Letter” key. The “Episode” key is a specialized key that toggles between a primary scene-field-specific keyboard (shown in FIG. 3A) and a secondary scene-field-specific keyboard (not shown). The secondary scene-field-specific keyboard can be opened by selecting the “Episode” key, which switches to a secondary scene-field-specific keyboard that allows the user to input an episode number, e.g., Ep#104. The second specialized key, the “Next Letter” button, allows a user to automatically advance the scene number to a next letter, e.g., 14→14A→14B. This allows a user to advance scene letters without having to include an entire keyboard with all 26 letters, thereby saving on limited display space.

In one embodiment, each field-specific keyboard can include a keyboard toggle icon 302. By selecting the keyboard toggle icon 302, the user can toggle between a regular, non-field-specific keyboard (e.g., a QWERTY keyboard), and the field-specific keyboard for the field the user is currently editing. As discussed above, each field can be associated with a scene-field-specific keyboard, and a scene-field-specific keyboard may include one or more specialized keys. In certain instances, certain specialized keys may be unique to a particular scene-field-specific keyboards, while other specialized keys may be utilized across various scene-field-specific keyboards. Furthermore, as will be seen in later examples, certain scene-field-specific keyboards (i.e., the combination of keys that define the scene-field-specific keyboard) may be unique, such that no other field has an identical combination of keys, while other scene-field-specific keyboards may be unique to a group of fields that utilize the same scene-field-specific keyboard.

FIG. 3B depicts an example roll-field-specific keyboard that is associated with the “roll” field, according to an embodiment of the present disclosure. The roll-field-specific keyboard provides numerical keys, to enter a roll number, as well as various punctuation keys that are commonly used in entering information in the roll field. The roll-field-specific keyboard also includes a specialized “Mag #” key that switches to a secondary keypad (not shown) for entering film magazine serial number information, and a specialized “Reload” key to automatically increment a roll number. The roll-field-specific keyboard also automatically adds an appropriate pre-selected camera index as a prefix to the roll number (e.g., if the entry is under Camera A, the prefix “A” is automatically added, or if the entry is under Camera B, the prefix “B” is automatically added).

FIG. 3C depicts an example lens-field-specific keyboard that is associated with the “lens” field, according to an embodiment of the present disclosure. The lens-field-specific keyboard provides numerical keys, for entering a lens length, and various punctuation keys (, . −) that are commonly used in entering information in the lens field. In one embodiment, the lens-field-specific keyboard automatically appends the unit “mm” to any lens length entered by the user. The lens-field-specific keyboard also includes a specialized “Lenses” key to open a secondary keypad for selecting lens make and model information, an example of which is depicted in FIG. 3D, according to an embodiment of the present disclosure.

FIG. 3E depicts an example stop-field-specific keyboard that is associated with the “stop” field, according to an embodiment of the present disclosure. The stop-field-specific keyboard includes numerical keys for entering a stop value, and various punctuation keys (. −) that are commonly used for entering stop information. The stop-field-specific keyboard also includes specialized fraction keys (¼, ⅓, ¾, ⅔, ½) to allow a user to easily enter fractional stop values. The stop-field-specific keyboard also includes a specialized “T/F” key, which switches the prefix automatically added to apertures between “T” and “F.”

FIG. 3F depicts an example time-code-field-specific keyboard that is associated with the “time code” field, according to an embodiment of the present disclosure. The time-code-field-specific keyboard includes numerical keys, as well as various punctuation keys (, : . −) for entering time-code information. The time-code-field-specific keyboard also has a specialized “Current Time” key to automatically set the field to the current time.

FIG. 3G depicts an example filter-field-specific keyboard that is associated with the “filter” field, according to an embodiment of the present disclosure. The filter-field-specific keyboard includes two punctuation keys (. ,). The filter-field-specific keyboard also includes two scroll lists, each scroll list comprising a plurality of keys. A first scroll list includes specialized keys corresponding to various types of filters, such as—Stops Internal ND filter, ND filter, POLA filter, IRND filter, FLAT filter, No Filter, etc. A second scroll list includes numerical keys (including various specialized fraction keys) used as descriptors of the selected filter type.

FIG. 3H depicts an example description-field-specific keyboard that is associated with the “description” field, according to an embodiment of the present disclosure. The description field is used to describe a particular take or shot associated with an entry. The description-field-specific keyboard includes two scrollable lists, each scrollable list comprising a plurality of keys. A first scrollable list includes keys corresponding to a list of words that can be used to describe a particular shot. This list can include, for example, the terms: pan, tilt, track, boom, left, right, up, down, in, out, to, from, forward, backward, wide, med, cu, over, etc. The list of words may be customizable, and, in various embodiments, may be user-defined and/or user-arranged. A second scrollable list includes a list of keys corresponding to character names for a particular production, such that character names can quickly and easily be inserted into the description field.

FIG. 3I depicts an example focus-field-specific keyboard that is associated with the “focus” field, according to an embodiment of the present disclosure. The focus-field-specific keyboard includes numerical keys for entering a focus distance, as well as specialized fractional keys for easily entering fractions (e.g., the “½” key). The focus-field-specific keyboard also includes one or more distance unit keys. In this case, the focus-field-specific keyboard includes an apostrophe key for the distance unit “feet” and a quotation mark key for the distance unit “inches.” FIGURE J depicts an example metric-units focus-field-specific keyboard that uses metric units (“m” and “cm”) instead of imperial units. In one embodiment, a user can specify a preference for imperial units or metric units and the focus-field-specific keyboard can be presented accordingly. In certain embodiments, the focus-field-specific keyboard shown in FIGS. 3I and 3J can also be used as a lens-height-field-specific keyboard associated with a “lens height” field. In other words, in one embodiment, the lens-height-field-specific keyboard can be identical to the focus-field-specific keyboard.

FIG. 3K depicts an example takes-field-specific keyboard that is associated with the “takes” field, according to an embodiment of the present disclosure. The takes-field-specific keyboard includes numerical keys for entering a take number, as well as various specialized keys “MOS,” “Tails,” and “PU” for entering additional details about a take.

FIG. 3L depicts an example shutter-field-specific keyboard that is associated with the “shutter” field, according to an embodiment of the present disclosure. The shutter-field-specific keyboard includes numerical keys for entering a shutter speed, as well as one or more specialized keys with pre-determined shutter speeds. For example, the example shown in FIG. 3L includes a key “180” so that the shutter speed “180” can quickly be entered by simply selecting that key. In certain embodiments, a user can specify one or more “default” shutter speeds for a camera or for a production. The default shutter speeds can be added as specialized keys in the shutter-field-specific keyboard.

FIG. 3M depicts an example color-temperature-field-specific keyboard that is associated with the “color temperature” field, according to an embodiment of the present disclosure. The color-temperature-field-specific keyboard includes numerical keys for entering a color temperature value, and also includes one or more specialized keys with pre-set color temperature values. For example, the example shown in FIG. 3M includes a “5600” key and a “3200” key for quickly entering these color temperatures. In certain embodiments, a user can specify one or more color default color temperatures for a camera or for a production. The one or more default color temperatures can be added as specialized keys in the color-temperature-field-specific keyboard. The color-temperature-field-specific can also include “+” and “−” keys for increasing or decreasing an entered color temperature.

FIG. 3N depicts an example FPS-field-specific keyboard that is associated with the “FPS” field (i.e., “frames per second” field), according to an embodiment of the present disclosure. The FPS-field-specific keyboard includes numerical keys for entering a frames-per-second value, but also includes one or more convenience keys with pre-defined FPS values. For example, the example shown in FIG. 3N includes a “24” key and a “23.976” key for quickly entering these values. In certain embodiments, a user can specify one or more “default” FPS values for a camera or for a production, and the default FPS values can be added to the FPS-specific keyboard as specialized keys.

FIG. 3O depicts an example ISO-field-specific keyboard that is associated with the “ISO” field, according to an embodiment of the present disclosure. The ISO-field-specific keyboard includes numerical keys for entering an ISO value, and also includes one or more specialized keys with pre-defined ISO values. For example, the example shown in FIG. 3O includes an “800” key for quickly entering this ISO value. In certain embodiments, a user can specify one or more “default” ISO values for a camera or for a production, and the default ISO values can be added to the ISO-specific keyboard as specialized keys.

FIG. 3P depicts an example tilt-field-specific keyboard that is associated with the “tilt” field, according to an embodiment of the present disclosure. The tilt-field-specific keyboard includes numerical keys for entering a tilt value, and also includes one or more specialized keys, such as the “up” and “down” keys for increasing or decreasing the tilt value. The tilt-field-specific keyboard also includes a specialized “Bubble” key for switching to a secondary tilt-field-specific keyboard, shown in FIG. 3Q. The secondary “Bubble” keyboard allows a user to use an internal accelerometer and/or gyroscope in his or her computing device to measure the actual tilt using the computing device. The user can select the “Done” key to enter the measured tilt into the “tilt” field.

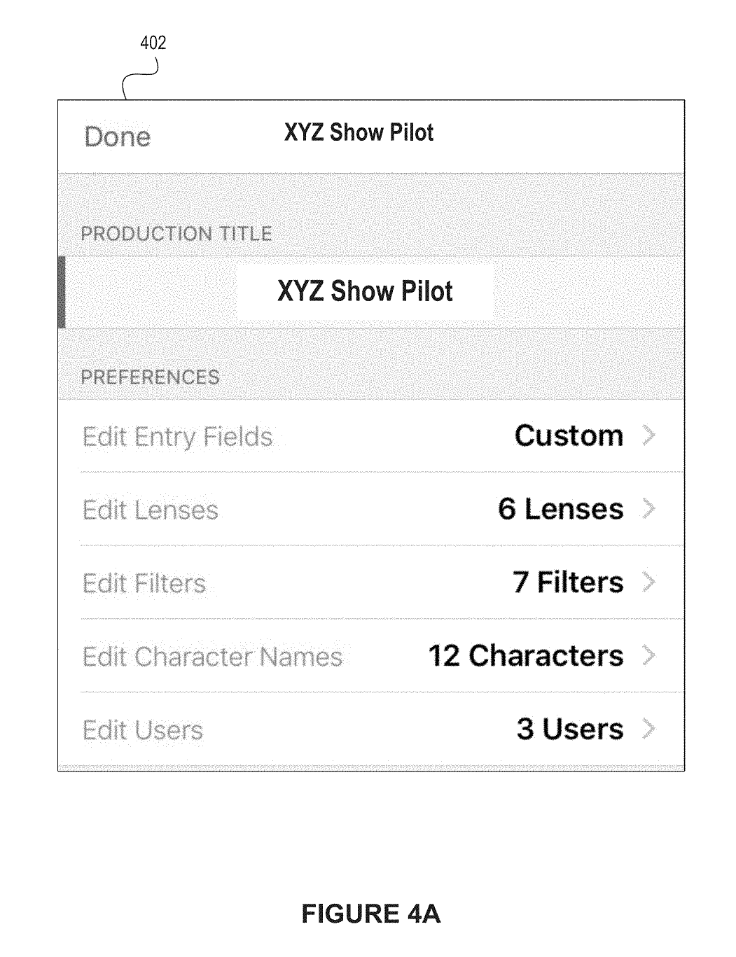

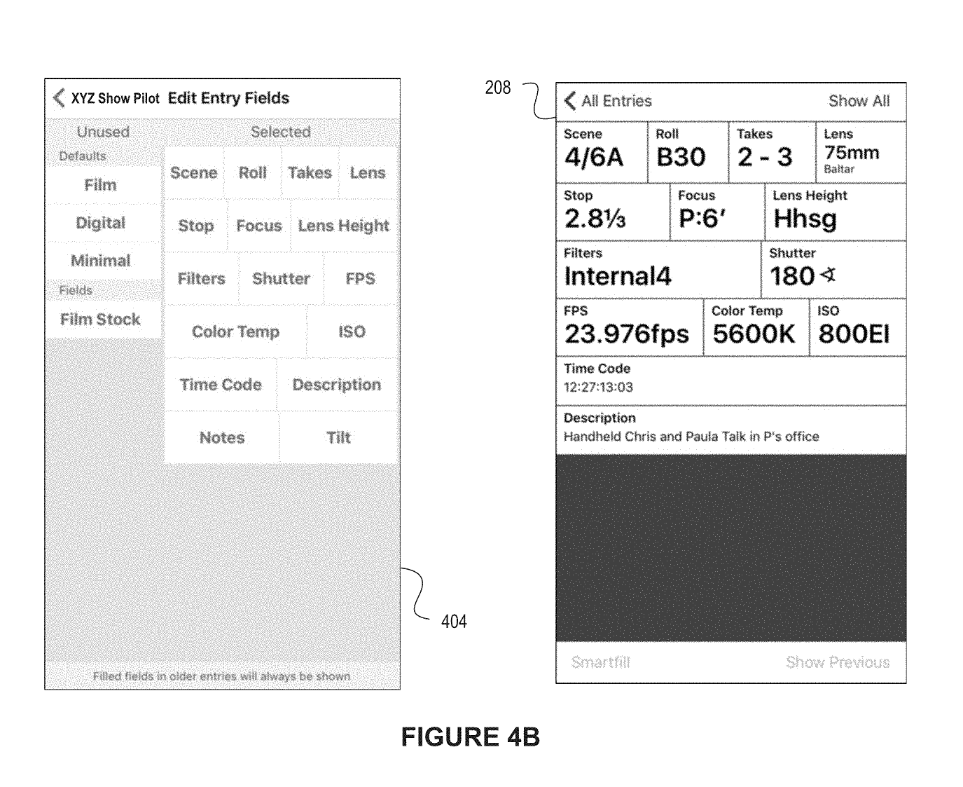

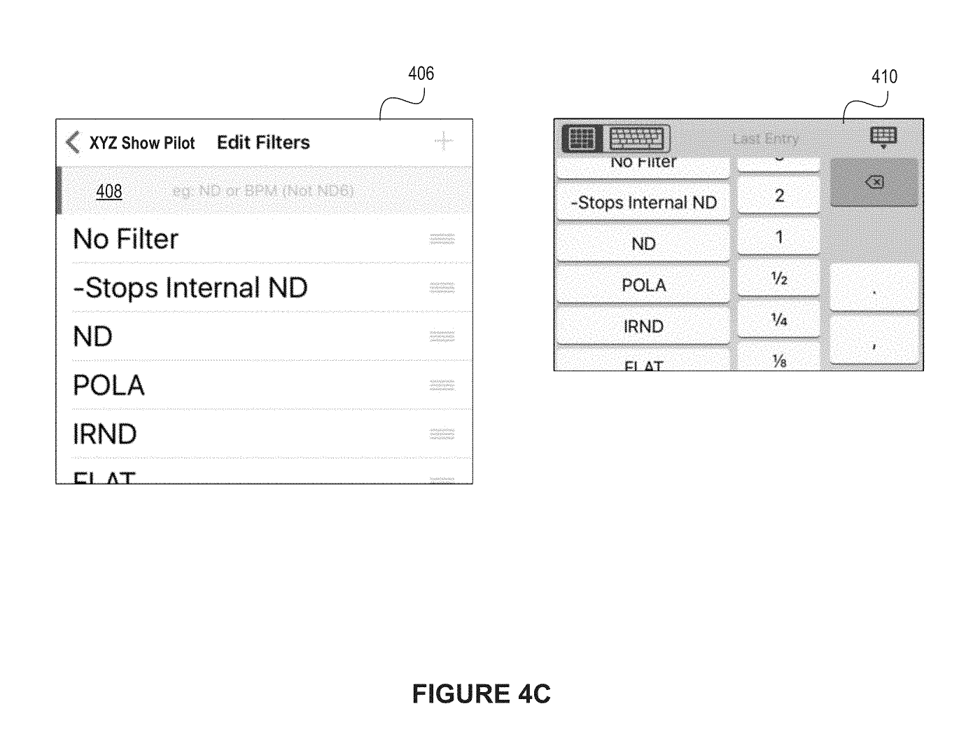

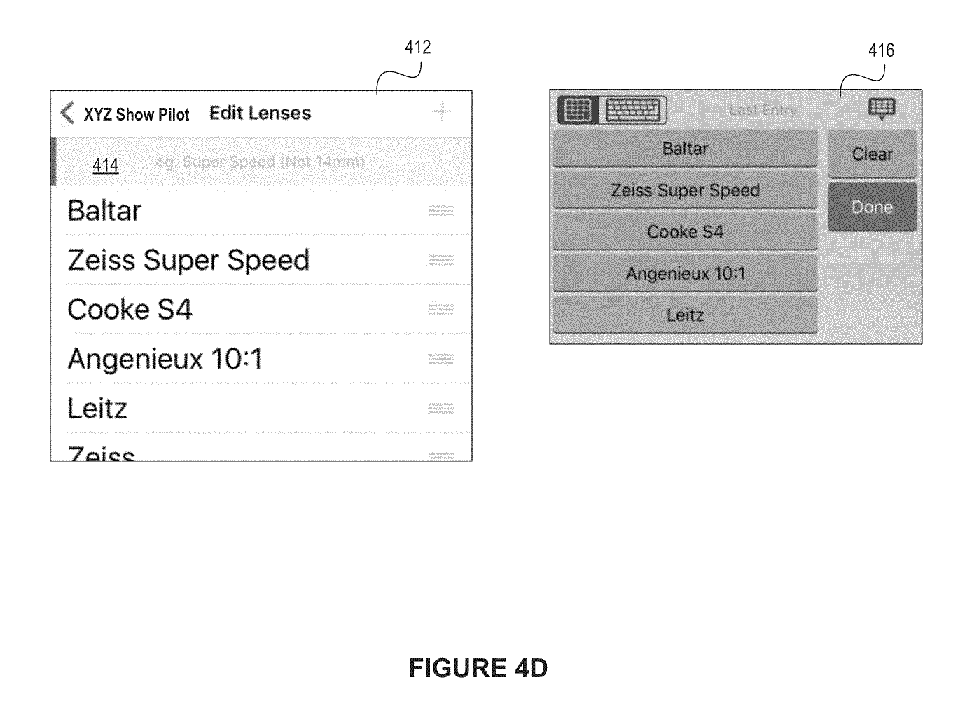

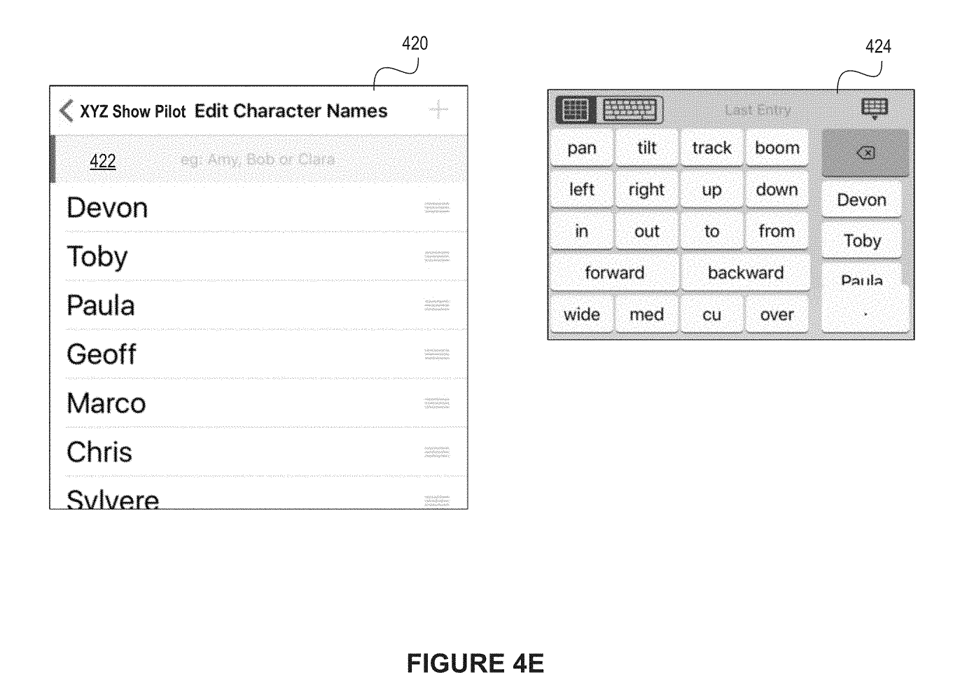

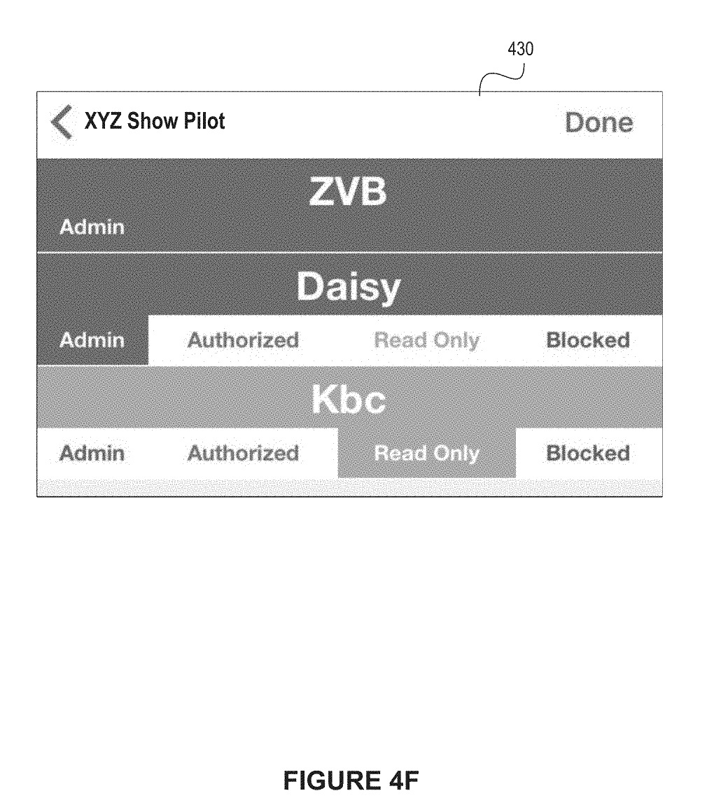

Returning to FIG. 1, the production editor module 106 can be configured to implement a production editor interface via which a user can edit production information associated with a production. For example, production information can include a list of lens filters used in a production, a list of lenses used in a production, a list of character names for a production, and a set of users that are associated with a production. In certain embodiments, modifying production information may cause a corresponding modification to an entry editor interface (e.g., the entry editor interface 208 of FIG. 2D) and/or one or more field-specific keyboards. For example, the production editor module 106 may allow a user to customize the entry fields that are presented in an entry editor interface for a production. In another example, the production editor module 106 can allow a user to specify the types of filters that are listed in a filter-field-specific keyboard. In another example, the production editor module 106 can allow a user to edit the types of lenses that are listed in a lens-field-specific keyboard. In another example, the production editor module 106 can allow a user to edit a list of characters for a production, which may affect a list of characters that are listed, for example, in a description-field-specific keyboard. In certain embodiments, the production editor interface can be used to define a set of users that are associated with a production. The production editor interface can also allow a user to specify permissions and/or access levels of any users associated with a production. Various example interfaces that can make up the production editor interface are depicted in FIGS. 4A-4F, each of which will now be described in greater detail.

FIG. 4A depicts an example production editor interface 402 that a user can utilize to modify production information for a production. In one embodiment, a user can access the example production editor interface 402 from the production selection interface 202 of FIG. 2A by selecting an “Edit” option on the top right hand corner of the production selection interface 202, and then selecting a production to edit. In the example production editor interface 402 of FIG. 4A, the user has opted to edit the production “XYZ Show Pilot.” It can be seen that the example production editor interface 402 includes various options that a user can select to modify different types of production information. For example, the user can modify the entry fields used in the production (FIG. 4B), the lenses used in the production (FIG. 4C), the filters used in the production (FIG. 4D), character names for the production (FIG. 4E), and users associated with the production (FIG. 4F).

FIG. 4B depicts an example entry field editor interface 404. A user can utilize the entry field editor interface 404 to customize the entry fields that are presented in an entry editor interface (e.g., the entry editor interface 208 of FIG. 2D). The entry field editor interface 404 comprises a plurality of moveable tiles, with each tile corresponding to a particular entry field. The entry field editor interface 404 includes an “Unused” column, and a “Selected” column. Any entry fields that are in the “Selected” column are included in the entry editor interface, while any entry fields that are in the “Unused” column are excluded from the entry editor interface. The user can drag entry field tiles between the two columns to customize which entry fields are included and/or excluded from the entry editor interface. In one embodiment, a user can determine a position for each entry field within an entry editor interface by, for example, arranging (e.g., by dragging) the entry field's tile within the “Selected” column in a particular order. For example, in the example entry field editor interface 404, the tiles in the Selected column are listed in a particular order: Scene, Roll, Takes, Lens, Stop, Focus, Lens Height, Filters, Shutter, FPS, Color Temp, ISO, Time Code, Description, Notes, Tilt. Accordingly, it can be seen that the entry editor interface 208 includes the entry fields arranged in the same order.

FIG. 4C depicts an example filter editor interface 406. Within the filter editor interface 406, a user can either select existing filters, or add new filters (via an entry field 408). By modifying the set of filters to be included in a particular production, the user can modify the selection options that are presented in a filter-field-specific keyboard 410 (such as the filter-field-specific keyboard shown in FIG. 3G).

FIG. 4D depicts an example lens editor interface 412. Within the lens editor interface 412, a user can either select existing lenses, or add new lenses (via an entry field 414). By modifying the set of lenses to be included in a particular production, the user can modify the selection options that are presented in a lens-field-specific keyboard 416 (such as the lens-field-specific keyboard shown in FIGS. 3C-3D).

FIG. 4E depicts an example character editor interface 420. Within the character editor interface 420, a user can either select existing characters, or add new characters (via an entry field 422). By modifying the set of characters to be included in a particular production, the user can modify the selection options that are presented in a description-field-specific keyboard 424 (such as the description-field-specific keyboard shown in FIG. 3H).

FIG. 4F depicts an example user editor interface 430 for managing users that are associated with a production. When a user installs and/or opens a motion picture production application on his or her computing device, the user may be required to log-in or identify themselves in one way or another. In one embodiment, when a member of a production (e.g., an administrator of the production) wishes to add users to a production, the administrator can search for a particular user using a user identifier (e.g., username or email address). In one embodiment, when the administrator attempts to add a user to a production, the user may receive a notification on his or her application that they have received an invitation to join the production. In one embodiment, if the user accepts the invitation, the user is added to the production. The user editor interface 430 allows a first user (e.g., an administrator) to define editing and data access capabilities for other users in a production. For example, the first user can mark another user as an administrator (or “Admin”), such that the other user can access and edit any information associated with the production. In another example, the first user can mark another user as “Authorized,” which, for example, allows the user to view and edit fields and/or field entries, but does not allow access to the “User Editor” to control user access permissions. Users that are tagged as “Read Only” can only view information, and cannot edit it. Users that are tagged as “Blocked” are not able to access any information for a production (e.g., users that previously had some access, but have been removed or fired from a production). In an embodiment, users that are not included in the user list for a production also do not have access to information for the production.

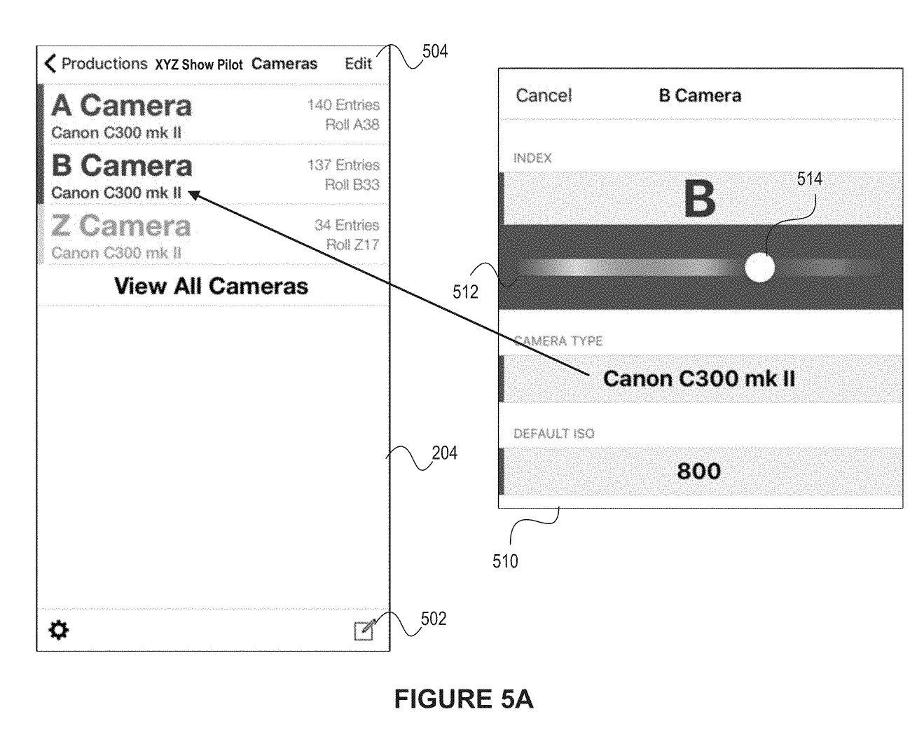

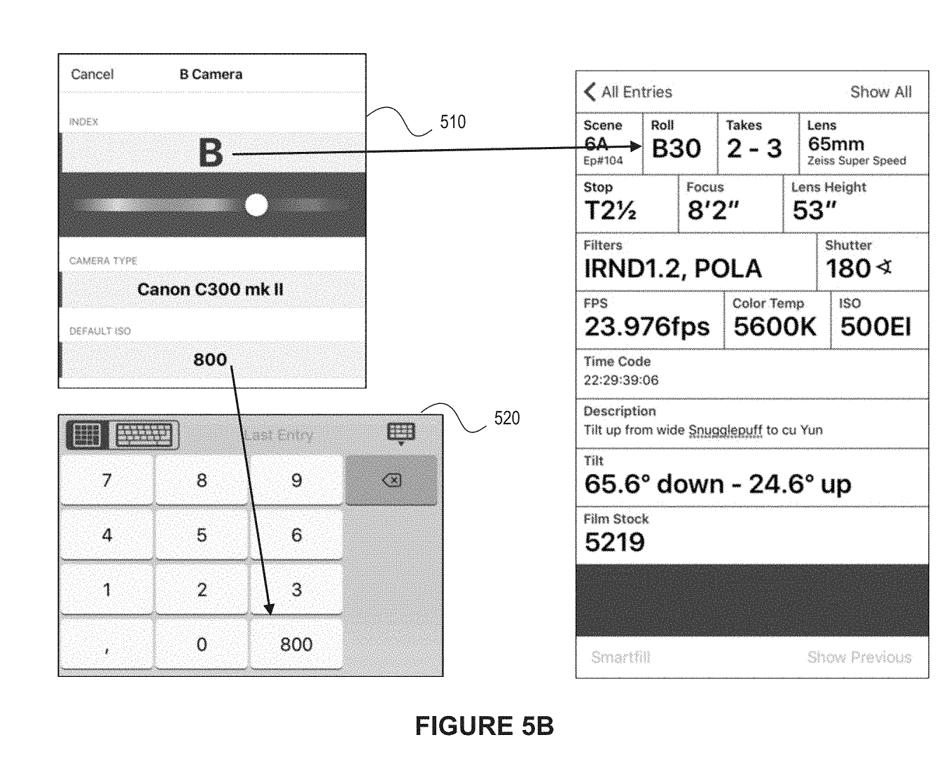

Returning to FIG. 1, the camera editor module 108 can be configured to implement a camera editor interface via which a user can specify camera information for a production. As mentioned above, each production can include and/or be associated with one or more cameras. In FIG. 5A, a camera selection interface 204 (previously depicted in FIG. 2B) shows three cameras, A Camera, B Camera, and Z Camera. A user can add a new camera to a production using a first icon 502. The user can revise an existing camera using a second icon 504. FIG. 5A depicts an example camera editor interface 510. In the example camera editor interface 510, a user may be revising existing camera “B Camera,” or defining “B Camera” for the first time. The camera editor interface 510 allows a user to enter an index or identifier for the camera (in this case, the index is “B”). As mentioned above, each camera can also be associated with a particular color. As such, the camera editor interface 510 includes a color gradient bar 512. The user can move a selector 514 along the color gradient bar 512 to select a color for the camera. In one embodiment, a camera is presented in the camera selection interface 204 based on its associated color. For example, if the camera “B Camera” is associated with the color blue, the text “B Camera” in the camera selector interface 204 can be presented in blue.

Within the camera editor interface 510, a user can also specify a camera type. The camera type field may be filled in using text entry, or the user may be presented with a list of camera types to choose from. The specified camera type is presented in the camera selection interface 204. The user can also enter a default ISO for the camera, which, in this case, has been set to 800. As can be seen in FIG. 5B, the default ISO for a camera can be used to define a specialized key for an ISO-field-specific keyboard 520 (such as the ISO-field-specific keyboard of FIG. 3O). Furthermore, for any entries associated with the camera (in this case, “B Camera”) the Roll Index (“B”) can be appended as a pre-fix for values entered into the Roll field.

Returning once again to FIG. 1, the update module 110 can be configured to communicate over a network such that motion picture information can be communicated over the network to multiple users. For example, when a user adds or revises information for a particular production (e.g., using the described entry editor interface, production editor interface, and/or camera editor interface), a set of users that have appropriate associations and/or permissions for the production can receive updated information on the applications installed on their respective computing devices such that all users on the production are consistently provided with up-to-date information. In certain embodiments, information entered into the application can be utilized in post-production processes (e.g., provided to post-production software and/or digital effects software), and/or utilized in subsequent shots or takes (e.g., used to set camera settings for subsequent takes or shots). In certain embodiments, the update module 110 can communicate updated motion picture information to multiple users associated with a production by updating a central data store or data repository (e.g., the data store 112) with updated motion picture information when a user enters updated motion picture information. Other users, when viewing their own motion picture production applications, can retrieve updated information from the central data store.

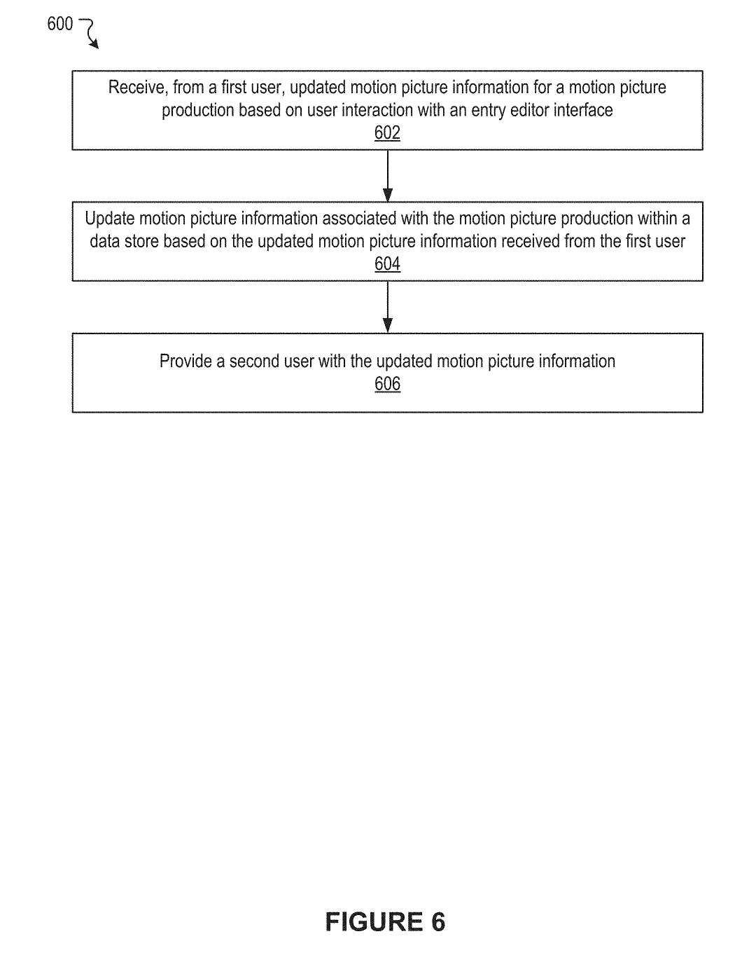

FIG. 6 illustrates an example method 600 associated with updating and sharing motion picture information using a motion picture production application, according to an embodiment of the present disclosure. It should be appreciated that there can be additional, fewer, or alternative steps performed in similar or alternative orders, or in parallel, within the scope of the various embodiments unless otherwise stated.

At block 602, the example method 600 can receive, from a first user, updated motion picture information for a motion picture production based on user interaction with an entry editor interface. At block 604, the example method 600 can update motion picture information associated with the motion picture production within a data store based on the updated motion picture information received from the first user. At block 606, the example method 600 can provide a second user with the updated motion picture information.

### Hardware Implementation

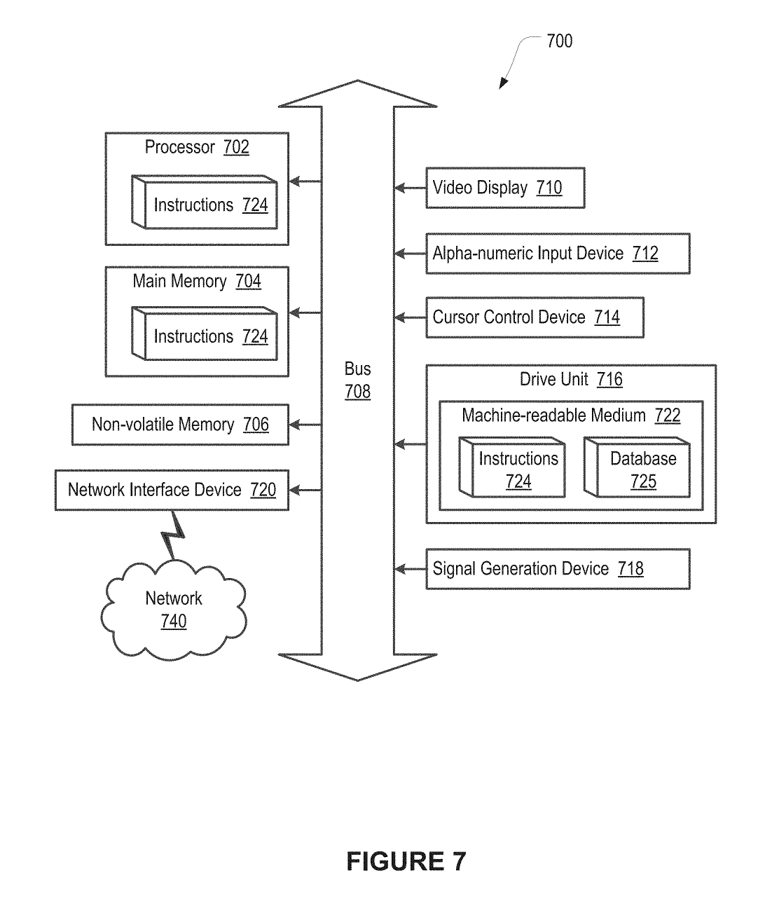

FIG. 7 is a diagrammatic representation of an embodiment of a machine 700, within which a set of instructions for causing the machine to perform one or more of the embodiments described herein can be executed. The machine may be connected (e.g., networked) to other machines. In a networked deployment, the machine may operate in the capacity of a server or a client machine in a client-server network environment, or as a peer machine in a peer-to-peer (or distributed) network environment. In one embodiment, the machine communicates with the server to facilitate operations of the server and/or to access the operations of the server.

The machine 700 includes a processor 702 (e.g., a central processing unit (CPU), a graphics processing unit (GPU), or both), a main memory 704, and a nonvolatile memory 706 (e.g., volatile RAM and non-volatile RAM), which communicate with each other via a bus 708. In some embodiments, the machine 700 can be a desktop computer, a laptop computer, personal digital assistant (PDA), a mobile phone, or a tablet, for example. In one embodiment, the machine 700 also includes a video display 710, an alphanumeric input device 712 (e.g., a keyboard), a cursor control device 714 (e.g., a mouse), a drive unit 716, a signal generation device 718 (e.g., a speaker) and a network interface device 720.

In one embodiment, the video display 710 includes a touch sensitive screen for user input. In one embodiment, the touch sensitive screen is used instead of a keyboard and mouse. The disk drive unit 716 includes a machine-readable medium 722 on which is stored one or more sets of instructions 724 (e.g., software) embodying any one or more of the modules, methodologies, and/or functions described herein. The instructions 724 can also reside, completely or at least partially, within the main memory 704 and/or within the processor 702 during execution thereof by the computer system 700. The instructions 724 can further be transmitted or received over a network 740 via the network interface device 720. In some embodiments, the machine-readable medium 722 also includes a database 725.

Volatile RAM may be implemented as dynamic RAM (DRAM), which requires power continually in order to refresh or maintain the data in the memory. Non-volatile memory is typically a magnetic hard drive, a magnetic optical drive, an optical drive (e.g., a DVD RAM), or other type of memory system that maintains data even after power is removed from the system. The non-volatile memory may also be a random access memory. The non-volatile memory can be a local device coupled directly to the rest of the components in the data processing system. A non-volatile memory that is remote from the system, such as a network storage device coupled to any of the computer systems described herein through a network interface such as a modem or Ethernet interface, can also be used.

While the machine-readable medium 722 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The term “machine-readable medium” shall accordingly be taken to include, but not be limited to, solid-state memories, optical media and magnetic media. The term “storage module” as used herein may be implemented using a machine-readable medium.

In general, routines executed to implement the embodiments of the invention can be implemented as part of an operating system or a specific application, component, program, object, module or sequence of instructions referred to as “programs” or “applications”. For example, one or more programs or applications can be used to execute any or all of the functionality, techniques, and processes described herein. The programs or applications typically comprise one or more instructions set at various times in various memory and storage devices in the machine and that, when read and executed by one or more processors, cause the machine to perform operations to execute elements involving the various aspects of the embodiments described herein.

The executable routines and data may be stored in various places, including, for example, ROM, volatile RAM, non-volatile memory, and/or cache. Portions of these routines and/or data may be stored in any one of these storage devices. Further, the routines and data can be obtained from centralized servers or peer-to-peer networks. Different portions of the routines and data can be obtained from different centralized servers and/or peer-to-peer networks at different times and in different communication sessions, or in a same communication session. The routines and data can be obtained in entirety prior to the execution of the applications. Alternatively, portions of the routines and data can be obtained dynamically, just in time, when needed for execution. Thus, it is not required that the routines and data be on a machine-readable medium in entirety at a particular instance of time.

While embodiments have been described fully in the context of machines, those skilled in the art will appreciate that the various embodiments are capable of being distributed as a program product in a variety of forms, and that the embodiments described herein apply equally regardless of the particular type of machine- or computer-readable media used to actually effect the distribution. Examples of machine-readable media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Alternatively, or in combination, the embodiments described herein can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description or discussed herein. In other instances, functional block diagrams and flow diagrams are shown to represent data and logic flows. The components of block diagrams and flow diagrams (e.g., modules, engines, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “another embodiment”, “certain embodiments,” “various embodiments,” or the like means that a particular feature, design, structure, or characteristic described in connection with the embodiment is included in at least one embodiment of the disclosure. The appearances of, for example, the phrases “according to an embodiment”, “in one embodiment”, “in an embodiment”, or “in another embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments but also variously omitted in other embodiments. Similarly, various features are described which may be preferences or requirements for some embodiments but not other embodiments.

Although embodiments have been described with reference to specific exemplary embodiments, it will be evident that the various modifications and changes can be made to these embodiments. Accordingly, the specification and drawings are to be regarded in an illustrative sense rather than in a restrictive sense. The foregoing specification provides a description with reference to specific exemplary embodiments. It will be evident that various modifications can be made thereto without departing from the broader spirit and scope as set forth in the following claims. The specification and drawings are, accordingly, to be regarded in an illustrative sense rather than a restrictive sense.

Although some of the drawings illustrate a number of operations or method steps in a particular order, steps that are not order dependent may be reordered and other steps may be combined or omitted. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention, both independently and as an overall system, and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Further, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps, but not the exclusion of any other element or step or group of elements or steps. Such terms should be interpreted in their most expansive forms so as to afford the applicant the broadest coverage legally permissible in accordance with the following claims.

What is claimed is:

1. A computer-implemented method comprising:
receiving, by a computing system, updated motion picture information for a motion picture production based on user interaction with an entry editor interface;
updating, by the computing system, motion picture information associated with the motion picture production within a data store based on the updated motion picture information received from the first user; and
providing, by the computing system, a second user with the updated motion picture information.

2. The computer-implemented method of claim 1, wherein
the entry editor interface comprises a plurality of entry fields, and
each entry field of the plurality of entry fields is associated with a field-specific keyboard for entering data into the entry field.

3. The computer-implemented method of claim 2, wherein a first field-specific keyboard associated with a first entry field comprises a specialized key.

4. The computer-implemented method of claim 3, wherein
the first entry field is a lens entry field, and
the specialized key is a lenses key which allows a user to select a lens from a set of pre-defined lenses.

5. The computer-implemented method of claim 3, wherein
the first entry field is a stop entry field, and
the specialized key is a fractional key which enters a pre-defined fractional value when selected by a user.

6. The computer-implemented method of claim 3, wherein
the first entry field is a time code entry field, and
the specialized key is a current time key which enters a current time when selected by a user.

7. The computer-implemented method of claim 3, wherein
the first entry field is a shutter entry field, and
the specialized key is a predefined shutter value key which enters a predefined shutter value when selected by a user.

8. The computer-implemented method of claim 3, wherein
the first entry field is a color temperature entry field, and
the specialized key is a predefined color temperature value key which enters a predefined color temperature value when selected by a user.

9. The computer-implemented method of claim 3, wherein
the first entry field is a FPS entry field, and
the specialized key is a predefined FPS value key which enters a predefined FPS value when selected by a user.

10. The computer-implemented method of claim 3, wherein
the first entry field is an ISO entry field, and
the specialized key is a predefined ISO value key which enters a predefined ISO value when selected by a user.

11. A system comprising:
at least one processor; and
a memory storing instructions that, when executed by the at least one processor, cause the system to perform a method comprising:
receiving updated motion picture information for a motion picture production based on user interaction with an entry editor interface;
updating motion picture information associated with the motion picture production within a data store based on the updated motion picture information received from the first user; and
providing a second user with the updated motion picture information.

12. The system of claim 11, wherein
the entry editor interface comprises a plurality of entry fields, and
each entry field of the plurality of entry fields is associated with a field-specific keyboard for entering data into the entry field.

13. The system of claim 12, wherein a first field-specific keyboard associated with a first entry field comprises a specialized key.

14. The system of claim 13, wherein
the first entry field is a lens entry field, and
the specialized key is a lenses key which allows a user to select a lens from a set of pre-defined lenses.

15. The system of claim 13, wherein
the first entry field is a stop entry field, and
the specialized key is a fractional key which enters a pre-defined fractional value when selected by a user.

16. A non-transitory computer-readable storage medium including instructions that, when executed by at least one processor of a computing system, cause the computing system to perform a method comprising:
receiving updated motion picture information for a motion picture production based on user interaction with an entry editor interface;
updating motion picture information associated with the motion picture production within a data store based on the updated motion picture information received from the first user; and
providing a second user with the updated motion picture information.

17. The non-transitory computer-readable storage medium of claim 16, wherein
the entry editor interface comprises a plurality of entry fields, and
each entry field of the plurality of entry fields is associated with a field-specific keyboard for entering data into the entry field.

18. The non-transitory computer-readable storage medium of claim 17, wherein a first field-specific keyboard associated with a first entry field comprises a specialized key.

19. The non-transitory computer-readable storage medium of claim 18, wherein
the first entry field is a lens entry field, and
the specialized key is a lenses key which allows a user to select a lens from a set of pre-defined lenses.

20. The non-transitory computer-readable storage medium of claim 18, wherein
the first entry field is a stop entry field, and
the specialized key is a fractional key which enters a pre-defined fractional value when selected by a user.
